(19) United States
(12) Patent Application Publication
(10) Pub. No.: US 2003/0089650 A1
(43) Pub. Date: May 15, 2003

(54) Automatic, renewable separation & filtration system for liquids

(76) Inventor: William Leonard Renfro, Washington, DC (US)

Correspondence Address: William Leonard Renfro, 1431 Thirty Third St., NW, Washington, DC, 20007, US

(21) Appl. No.: 10/262,299

(22) Filed: Oct. 2, 2002

Related U.S. Application Data
(60) Provisional application No. 60/326,395, filed on Oct. 2, 2001.

(51) Int. Cl. B01D 35/147

(52) U.S. Cl. 210/130

(57) ABSTRACT

A multiple stage automatic, low-to-no back pressure, high capacity, continuously renewable, separation and filtration system for the contaminated liquids which are discharged into the environment including means to add air to the contaminated liquids as they moved into a vertical elongated hydrostatic chamber wherein the action of gravitational forces and added air separates the contaminants from uncontaminated liquids, with a detachable bottom container for collecting and holding heavier contaminants and a large capacity upper chamber for collecting and holding lighter contaminants with a drain valve for the subsequent environmentally safe disposal of these lighter contaminants liquids, where the out flow of this vertical elongated chamber passes through a generally smaller filter canister composed of a hydrophobic, contaminant attracting filtering material which captures the remaining trace solid and liquid contaminants suspended in the out flow of the hydrostatic chamber.

### FIELD OF THE INVENTION

This invention relates generally to mechanical systems for separating from each other contaminated and un-contaminated liquids which have different specific gravities or which have low coefficients of absorption for each other or which have both different specific gravities and low mutual absorption coefficients. These systems allow the separated liquids and particulates to be processed for disposal, reuse or recycling in accordance with environmental laws. These liquids include aqueous liquids from which must be removed chemical and biological contaminents including hydrocarbon-based liquids and solids used to fuel, lubricate, cool or operate motors, transmissions, gears, bearings, hydraulic systems, internal and external combustion engines, among other mechanical systems. Removal of these contaminants from the aqueous liquids is required prior to the discharge of the aqueous liquids to assure that the disposal or discharge of the aqueous liquids is not in violation of environmental laws. A similar removal of contaminents is required of any liquid waste that is discharged on land or into sewage or storm drainage systems, streams, rivers, wetlands, etc.

The present invention is directed to a novel, two stage automatic, high capacity, continuously renewable, separation and filter system for separating from liquids which may be legally discharged into the environment from liquids and liquid-borne particulates which may not legally be discharged into the environment. More particularly, the present invention is directed to a two stage separation and filter system wherein hydrostatic pressure in conjunction with hydrophobic filters is employed which function to separate and retain liquid and solid contaminants for subsequent disposal as required by environmental regulations.

Even more specifically, the present invention concerns a hydrostatic chamber or tank for separating, collecting and capturing liquid and solid contaminants, incorporating an externally supported, generally elongated, vertically mounted chamber or tank through which the contaminated liquids are caused to flow by action of a pump. The present invention is particularly useful in processing the liquids which collect around and under machines and which mix with aqueous liquids from ambient sources including condensation, rain, leaks, among others.

To prevent these contaminated liquids from spreading beyond the immediate area of their sources, a pan, sump, catch-basin or other similar device with a surface area sufficient to capture the liquids falling from the ambient sources is frequently employed and in some applications, required by law. Eventually, this mix of aqueous and contaminated liquids must be removed from the catch-basin and processed for disposal, reuse or recycling in accordance with environmental laws. These liquids are removed by a pump from under the machinery to a holding facility for later disposal. In this removal process, these liquids are subjected by the pump to a pressure sufficient to lift them up from the catch-basin to the in-take of the holding facility for later disposal. In the case of ships and craft of all sizes, this pressure is sufficient to move the liquids up from the bottom of the hull which operates as a catch-basin to at least the level of the sea around the ship for discharge over-board. For safety the discharge point is located at least several feet above the leverl of the sea aaround the ship. Even in the smallest ships and craft, this pressure must be sufficient to lift the liquids several feet to sea level and then several more feet to the discharge point.

While in the hydrostatic chamber, the contaminated liquids are slowed and subjected to the hydrostatic pressure generated within the chamber by the height of the liquids in the chamber. This hydrostatic pressure is much greater than that experienced by the liquids when in they were in the catch-basin which has a large surface area relative to its depth. This greater hydrostatic pressure efficiently separates the lighter liquids and heavier particulates present in the liquids delivered from the catch-basin by the pump. In applications where these liquids are from catch-basins under and around motors, transmissions, gears, bearings, hydraulic systems, internal and external combustion engines, among other mechanical systems dependent on substances whose use, storage and disposal is subject to environmental regulations, the contaminents are composed of or contain hydrocarbons which are lighter than more voluminous aqueous liquids and also have a low coefficient of solubility with aqueous solutions. The low mutual absorption coefficients of these fluids enhances the separation process.

In the case of ships and even small, powered craft, the liquids collecting under and around the various motors, engines, generators and machinery contain a wide variety of hydrocarbon-based liquids which may not legally be discharged over board. While efforts are made to capture and contain these hydrocarbon-based liquids as close to the source as possible, substantial amounts invariably end up in the bottom of the ship. The normal motion of a ship under way keeps these contaminents in a constant state of mixing with aqueous and other liquids that may be present. The resulting mix of liquids includes primarily larger volumes of aqueous liquids from which must be removed much smaller volumes of chemical and biological contaminents including hydrocarbon-based liquids and solids used to fuel, lubricate, cool or operate motors, transmissions, gears, bearings, hydraulic systems, internal and external combustion engines, among other mechanical systems.

At the same time, small, powered craft and even large ships, cannot hold any significant volume or weight of contaminated liquids on board without raising issues of efficiency, stability, safety and performance. Some device must be used to separate contaminants from the liquids which may legally be discharged overboard. When the safety of a ship is threatened, violating environmental regulations becomes a necessary evil as contaminated liquids pumped over-board.

The separation system of the present invention includes two stages wherein hydrostatic pressure is employed first to separate, capture and retain contaminating liquids and suspended particulates according to their different specific gravities for subsequent disposal as required by environmental regulations for each type of liquid. Second, the liquids from which contaminents were removed in the first stage are transported to a second state which employs a filter to capture residual suspended particulates not captured by the action of hydrostatic pressure. Even more specifically, the present invention concerns an hydrostatic chamber for separating, collecting and capturing hydrocarbon-based liquids, suspended particulates and other contaminants present in agueous liquids, incorporating an externally supported, generally elongated, vertically mounted chamber or tank through which the aqueous liquids are caused to flow by action of a pump. While in the chamber, the aqueous liquids are slowed and subjected to the hydrostatic pressure generated within the chamber by the height of the liquids in the chamber. This hydrostatic pressure is much greater than that experienced by the liquids when in they were in the catch-basin which have a large surface area relative to their depth. This hydrostatic pressure efficiently separates the lighter liquids and heavier particulates present in the liquids delivered from the catch-basin by the pump. In applications where these liquids are from catch-basins under and around motors, transmissions, gears, bearings, hydraulic systems, internal and external combustion engines, among other mechanical systems dependent on substances whose use, storage and disposal is subject to environmental regulations, the contaminents are composed or contain hydrocarbons which are lighter than more voluminous aqueous liquids and also have a low coefficient of solubility with aqueous solutions.

### BACKGROUND OF THE INVENTION

The problem of separating liquids subject to environmental regulations from those which are not is a common problem, occurring virtually everywhere the regulated liquids are present. Garages, construction sites, factories, manufacturing plants, ship yards, aircraft hangers, repair facilities of all kinds, ships and even small, powered craft, storage tanks, pipe lines, etc., have, consume, use, or generate as by products contaminated liquids which are subject to environmental regulations at final disposal.

While this is an increasingly serious environmental problem in all land base facilities, the problem is most acute on board ships and even small craft. The problem is so serious that federal law not only prohibits the discharge to the environment of liquids contaminated with hydrocarbon-based chemicals used to fuel, lubricate, cool or operate motors, transmissions, gears, bearings, hydraulic systems, internal and external combustion engines, among other mechanical systems, but federal law also requires a notice to this effect to be posted next to every switch operating a pump that might discharge a regulated contaminant into the environment.

A wide variety of mechanical methods have been used for collecting and/or separating from unregulated liquids, those liquids which contain chemicals, compounds and substances whose discharge or disposal is regulated by environmental laws. These mechanical methods include skimmers, selective absorption devices, including wood chips and shavings, absorbent pads, and other bulk materials added in situ to the liquids containing regulated and unregulated components to hold and retain regulated substances while not retaining unregulated substances. While absorption devices work well for select contaminents, they become saturated quickly and are then unable to absorb other contaminants which are more thoroughly mixed with unregulated liquids.

An entirely different approach involves the addition of chemical solvents and dispersants to the contaminated liquids to promote by chemical action the mixing of liquids with low coefficients of absorption for each other. While these additives reduce or eliminate the visual evidence of the presence of lighter solids and liquid contaminants, including hydrocarbons, hydrocarbon-based and hydrocarbon-containing contaminants, the EPA has now recognized that the contaminants dispersed and/or rendered more soluable by the action of additives do more damage to the aqueous environment than they do in their unaltered state. For this reason, these additives may not be used to reduce or eliminate the appearance of surface contaminants in a liquid after it has been discharged into the environment. It is reasonable to expect in the near future the use of these chemical additives in contaminated liquids before they have been discharged will also be banned. New biological additives which contain microbes that consume and breakdown the hydrocarbons rather than hide or disguise them will probably not be banned. Hence, mechanical separation of contaminants will remain an important pollution control system as chemical dispersants are subject to greater and greater restrictions or are banned entirely.

While the lighter liquids of two or more liquids with low coefficient of absorption for each other will float on the top of the heavier ones due to the effect of gravitational forces acting on their different specific densities, the surface tensions of the two or more liquids and that of aqueous liquids act to prevent a complete separation of the liquids, especially aqueous liquids and liquids containing hydrocarbon-based substances, liquids, lubricants, fuels, hydraulic and automatic transmission liquids, cleaners, thinners, paints and runoff from surfaces made from or covered with hydrocarbon based substances.

The separation forces of hydrostatic pressure due to gravitational effects are small where the specific densities of the two or more liquids are similar and where the depth of the liquids is small as in most catch-basins, including the bottom of the hulls of ships. These catch-basins are usually very shallow, with a large ratio of surface to volume. Moreover, where a surface area is large, the forces of the surface tensions of the different liquids play a greater role. This is the circumstance of most bottom of the hulls of ships where a relatively large volume of aqueous liquids with a large surface area is contaminated with a much, much smaller volume—one tenth to one hundredth or even a thousandth or less of the volume of aqueous liquids—being comprised of hydrocarbon-based or hydrocarbon-ridden contaminants. Not only are the hydrostatic separation forces small and the effects of the surface tensions enhanced by the large surface area relative to the small volume of liquid contaminants, this mixture of aqueous liquids and contaminants is constantly stirred by the motion of the vessel, fighting and preventing the little separation which naturally occurs. In addition, the surfaces and structures where the aqueous liquids are being sloshed and stirred are coated with the contaminants which remain even after the area is purged of the contaminated liquids, remaining ready to contaminate for years to come, otherwise uncontaminated liquids.

In these circumstances, a pump will pick up at least some of the partially dissolved hydrocarbons mixed in the aqueous liquids and among the surface layers. This is true even for pumps with intakes mounted at the deeper recesses of the catch-basin. More often, the pump will also pick up some of the heavier contaminants suspended in or floating in the aqueous liquid or sitting on the bottom of the catch-basin. The action of the pump, especially the smaller centrifugal pumps, serves to increase the mixing of the liquid contaminates with the aqueous liquids so the presence of the liquid contaminates may not immediately be obvious when the aqueous liquid is discharged, only appearing after a few seconds or minutes. Where the aqueous liquid is cooler than the liquids into which it is discharged, the higher temperature of the these liquids acts to increase the separation of contaminated liquids resulting in the appearance of surface contaminates that were not visible in the catch-basin when the contaminated liquid was cooler and the hydrostatic and thermal separation forces were smaller.

For purposes of the present invention the term “contarninates” includes a wide variety of hydrocarbon-based products as well as products containing petroleum and hydrocarbons such as engine lubricating liquids, diesel fuels, gasolines, transmission liquids, hydraulic liquids, paints, paint thinners, paint strippers, de-glossers, power steering and brake liquids, etc. In the operation of virtually all engine powered ships and craft having inboard engines, a wide variety of hydrocarbon-based products are utilized in conjunction with engine operation. During operation of an engine or engines, a certain quantity of liquid contaminates can be lost through engine seals and into the catch-basin of the vessel. Regardless of how clean and how well cared for is the engine system of the vessel, it is virtually always the case that at least a small amount of liquid contaminates is lost from the engine into the catch-basin as the engine operates and ages. These liquid contaminates tend to coat all of the exposed surfaces in the catch-basin and can combine with other contaminants such as dust, certain aqueous life to develop a coating or buildup of sticky residue in the catch-basin. Also, during operation of an engine and during servicing of the engine, small amounts of lubricating liquids and other hydrocarbon-based liquids such as hydraulic and transmission liquids are frequently lost into the catch-basin. Some fuels or fuel components also find their way into the catch-basin due to minute leakage during extended engine operations.

Inboard engines, especially in larger ships typically have power output drive shafts that extend through seals in wall surfaces of the vessel, especially the bottom and transom surfaces. Many ships rely on “stuffing boxes” to provide seals on their propeller shafts. Stuffing boxes rely on a small amount of leakage for cooling as the shaft turns. Eventually, even those rotary shaft seals not designed to leak are usually subject to a small volume of leakage as they age. This leakage will build up in the catch-basin of the vessel. Consequently, the catch-basin must be periodically emptied by pumping its contents overboard to the environment.

Since contaminated liquids from engines, transmission and machiner and uncontaminated liquids from shaft seals and other leaks continuously collect in the catch-basin, the liquids in the catch-basin is virtually always contaminated. Even where there is no new leakage of contaminates from the engines, aqueous liquids pick up old contaminates coating the surfaces of the catch-basin. In the past, pumping systems have been provided which operate automatically or by manual selection and which function to pump the aqueous liquids, even those containing contaminates, out of the catch-basin and into the environment.

In these circumstances on board ships, pumping or discharging contaminated liquids into the environment violates the Exxon Valdeze Anti-Pollution Act and subjects the owner of the vessel to fines up to $50,000 per incident and seizure of the ship in addition to other penalties set out in overlapping federal, state and local laws.

To minimize the potential for violating laws banning the discharge of contaminants into the environment, many vessel operators mount their catch-basin pump intakes as low in the catch-basin as far away as possible from visible contaminants floating on the surface of the catch-basin. Of course, a ship rolling in even a moderately disturbed sea will have its aqueous liquids so mixed that the catch-basin pump cannot avoid the discharge of contaminants. Very few catch-basins, including those on ships, are provided with any facility for separation of the contaminated from uncontaminated liquids and thereby preventing contaminants from being discharged from the catch-basin and into the environment. Also, under circumstances where aqueous liquid filters have been employed, the filters are not usually capable of containing a significant volume of contaminants; consequently they are not usually capable of providing for lengthy unattended service so that either contaminant leakage from the filters becomes a problem or the filters become blocked preventing the catch-basin pump from accomplishing its primary, essential job—i.e., removing liquids from the catch-basin.

Certain ships such as commercial shrimp and fishing vessels, drilling rig service vessels, Navy ships, research vessels and the like may operate for several days, weeks or even months without returning to shore. In the case of aqueous liquid filtering systems it is desirable even under extended use of this nature to provide aqueous liquid filtering systems having the capability of being replenished or restored so that the vessel is always provided with the capability for efficiently filtering contaminant from the aqueous liquid and thus insuring that no contaminants or other such contaminants are discharged into the aqueous environment by the catch-basin pump system. When ships are operational for extended periods of time, it is essential for aqueous liquid separation and filtration systems to have either a sufficient capacity to maintain optimal, effective and efficient operation for extended periods or as in the case of the present invention, in addition to having a large capacity, a renewable capability by periodic removal of the collected contaminants and contaminants from the separation and filtration system.

### SUMMARY OF THE INVENTION

It is a principle feature of the present invention to provide a novel, two stage automatic, high capacity, low-to-no back pressure, continuously renewable, separation and filter system for separating contaminated from uncontaminated liquids and having the capability of containing a large volume of the separated contaminated liquids for separate disposal according to environmental regulations and a large capacity filter for capturing dissolved particulates discharged from the hydrostatic separator.

It is also a feature of the present invention to provide a novel, two automatic, high capacity, low-to-no back pressure, continuously renewable, separation and filter system for ships which envisions utilization of blocked-filter pressure relief by-pass valves which direct flow first to a second or back-up hydrophobic filter and then, if that filter is also blocked, then to a shunt to the discharge line.

It is an further feature of the present invention to provide a novel, automatic, low-to-no back pressure, high capacity, continuously renewable, two stage petroleum separation and filtration system for the liquids which must be discharged overboard into the environment which is provided with a vertical elongated chamber with detachable bottom container for heavier sludge particles and a large capacity upper chamber with a drain valve for the subsequent environmentally safe disposal of the lighter contaminated liquids, where the out flow of this chamber passes through a generally smaller filter canister composed of a hydrophobic, contaminant attracting filtering material which captures the remaining trace solid and liquid contaminants suspended in the out flow of the hydrostatic chamber.

It is another important feature of the present invention to provide a novel contaminant separation system for catch-basins on land and on ships wherein the current and future contaminanted liquids do not have to pass through the contaminants collected in the past, thereby insuring discharge of substantially contaminate free liquids from the catch-basin to the environment.

Briefly, the various objects and features of the present invention are realized through the provision of an automatic contaminant separation and filtration system having an vertically mounted, generally cylindrical or tubular housing having a series of internal funnels directing the lighter liquids upward and the heavier liquids downward in which the lighter liquids are captured at the top and heavier liquids and solids are captured at the bottom with a clean outlet at an intermediate level. This generally cylindrical or tubular housing can be made of plastic, metal, glass, a composite material or other materials impervious to the contaminates being processed.

At the upper end of the hydrostatic separation chamber there is provided a tube and valve which allows the collected lighter contaminants to be passed out of the hydrostatic chamber into an external container for disposal according to environmental requirements. An alternative has an attached collection chamber provided with an inlet through which lighter contaminants are directed into the collection chamber which is easily detachable, emptied and re-attached.

The inlet and outlet passages of the hydrostatic separation and filtration assembly are each adapted for connection to the flexible hoses of a catch-basin pump and aqueous liquid discharge system. Thus, the entire filter housing may be easily connected to and disconnected from the system handling the contaminated liquids in the catch-basin and may be easily installed, removed or replaced without necessitating the use of special tools or equipment. The upper collection chamber for lighter contaminants and the lower collection chamber for heavier contaminants may be easily disconnected from and re-connected to the hydrostatic separation system and may be easily installed, removed or replaced without the use of any specialized tools. In this manner, separated contaminates can be removed from the separation system and stored until the collected contaminates can be suitably disposed according to applicable environmental regulations,

### BRIEF DESCRIPTION OF THE DRAWINGS

In the Drawings:

FIG. 1 is a filter chamber of a hydrophobic filter element with an automatic by-pass valve for a blocked filter;

FIG. 2 is a filter chamber of a hydrophobic filter element and a back-up filter with an automatic by-pass valve for a blocked filter;

FIG. 3 is a hydrostatic separation and filtration chamber with vertically reversing flow direction to promote capture of lighter contaminants in traps at the top of the chamber and pass them into an upper collection chamber;

FIG. 4 is an end view of the upper traps for lighter contaminants with drain holes;

FIG. 5 is a hydrostatic filtration chamber with horizontally reversing flow direction to promote capture of lighter contaminants in traps at the top of the chamber and pass them into an upper collection chamber;

FIG. 6 side view of the stem of a small craft showing the location of the catch-basin pump, the separation chamber and the filtration chamber as well as discharge port for the decontaminated liquids.

FIG. 7 is a vertically mounted hydrostatic separation and filtration chamber with internal funnels to direct the lighter liquids to the top and the heavier liquids to the bottom, where the height of the vertically mounted separation chamber is at least the height of the aqueous liquid discharge tube;

FIG. 8 is a hydrostatic separation and filtration chamber with a detachable collection chamber at the top for lighter contaminants;

FIG. 9 is a hydrostatic separation and filtration chamber with an air-bleeding recycling system to promote the separation of lighter and heavier liquids by bleeding air into the catch-basin pump intake;

FIG. 10 is a hydrostatic separation and filtration chamber with a detachable collection chamber at the bottom for collection of heavier solid and liquid contaminants;

FIG. 11 shows an automatic valve for releasing air bleed into the intake of the catch-basin pump;

FIG. 12 is a hydrostatic separation and filtration system with an automatic air re-cycling system with a filter which removes hydrocarbon vapors from the re-cycling air;

FIG. 13 shows a hydrostatic separation and filtration system in which the upper and lower portions of the chamber are connected by two tubes or pipes, one of which carries the air and lighter liquids into the upper chamber and a return tube or pipe which directs the heavier liquids back to the lower reaches of the lower chamber;

FIG. 14 shows a free standing hydrostatic separation and filtration system not attached to catch-basin pump, but using a low pressure circulating pump;

FIG. 15 shows the free standing hydrostatic separation and filtration system using expansion power of heat in lieu of a circulating pump;

FIG. 16 is a hydrostatic separation and filtration system with an independent re-recirculating pump, a means to add salt to the chamber and a tube to allow heavier salts to mix with incoming liquids;

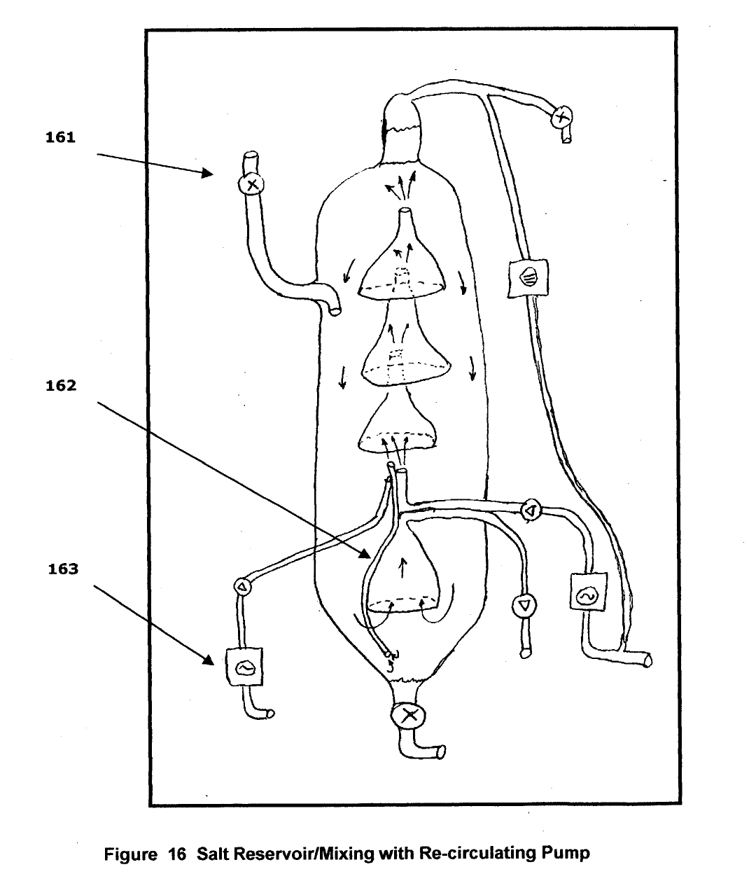

FIG. 17 shows a two stage separation and filtration system attached to the output of a catch-basin pump with a one piece first stage automatic hydrostatic separation and filtration system with heater and re-cycling air-bleed system with an internal salt supply with a second small re-circulating pump and second stage hydrophobic filtering system with its output attached to the aqueous liquid discharge pipe which has near the discharge point a drain hole for the small volume of re-circulating liquids to be returned to the catch-basin;

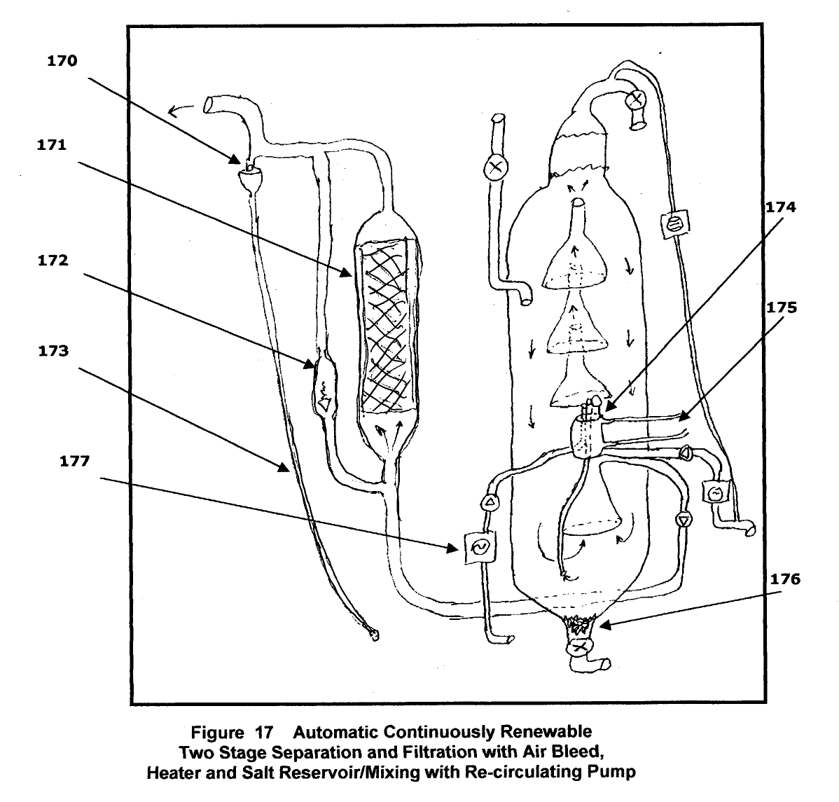

FIG. 18 shows a skimming intake for the small circulating pump; and

FIG. 19 shows the preferred embodiment two stage separation and filtration system attached to the output of a catch-basin pump with a first stage automatic hydrostatic separation and filtration system of flexible design having upper and lower chambers with heater and recycling air-bleed system with an internal salt supply with a second small re-circulating pump and second stage hydrophobic filtering system with its output attached to the aqueous liquid discharge pipe which has near the discharge point a drain hole for the small volume of re-circulating liquids to be returned to the catch-basin.

### OVERVIEW AND CONSTRUCTION OF THE SEPARATION SYSTEM

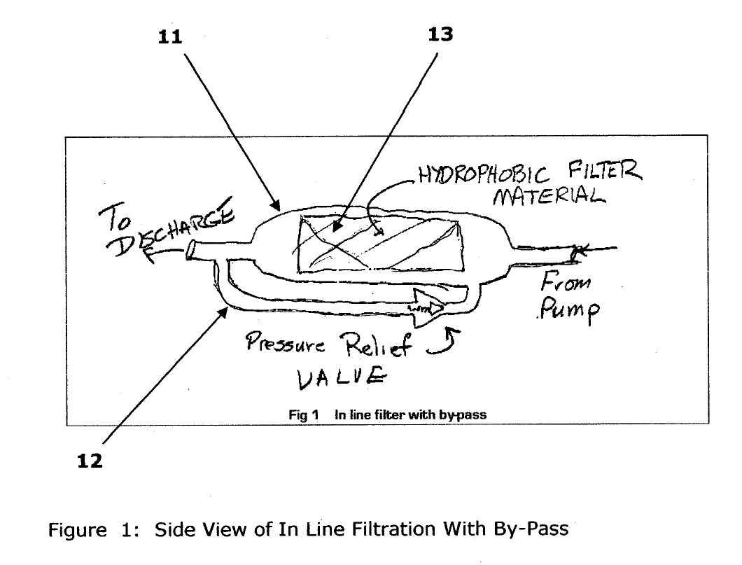

One way to prevent or greatly reduce the discharge of contaminants in aqueous liquid is to pass the aqueous liquid through an in-line filter (11) of hydrocarbon-retaining, hydrophobic material such as the aerated plastic found in contaminant-absorbent sheets (13) used in contaminant spills, before it is discharged into public sewage or storm drains. See FIG. 1. As this filter will eventually be saturated with contaminants and will restrict flow of the contaminated liquids from the pump, limiting the effectiveness of the catch-basin pump in an application on land and in an application on a ship, endangering the safety of the ship, a by-pass (12) for a clogged filter is necessary.

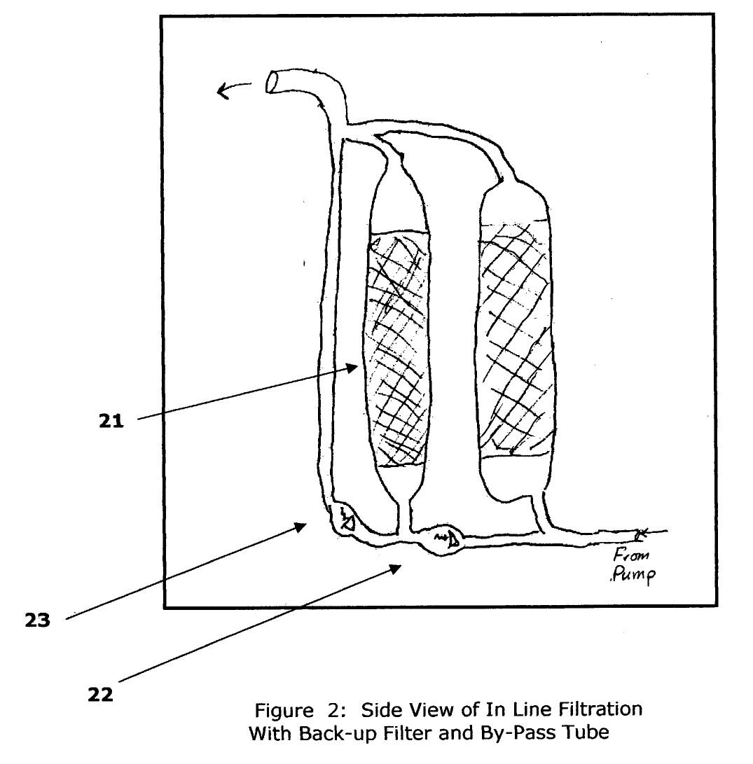

Since the in-line filter will eventually become saturated, an alternate filter (21) with a pressure relief valve (22) set to open when the first filter's back pressure reaches a point where it inhibits the action of the catch-basin pump in doing its job of removing liquids from the catch-basin and when this back-up filter is saturated, a second pressure relief valve (23) opens the bypass tube as shown in FIG. 2.

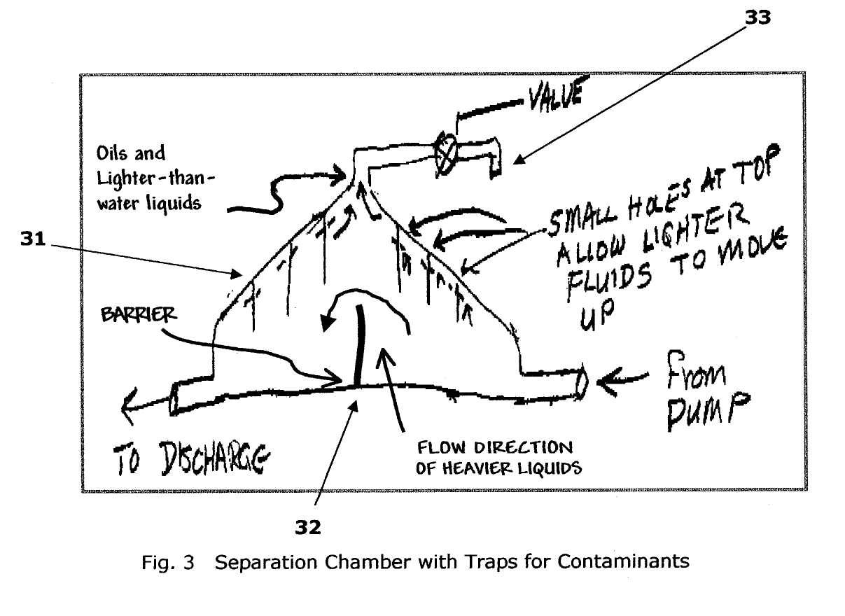

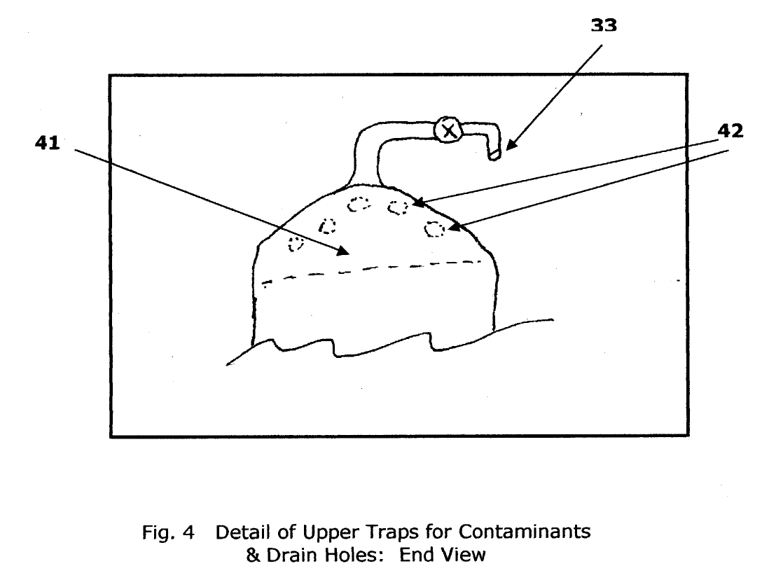

Lighter liquids can be automatically separated from heavier liquids by means of the action of traps (31) located at the top of the collection chamber as shown in FIG. 3 and in FIG. 4. In these traps the liquids from the pump are forced to reverse direction from an upward path to a downward path by the direction of the input, location of the output pipe and the shape of the chamber. The traps in the upper portion are designed to capture the lighter liquids and hold them at the top of the chamber while allowing the heavier liquids to exit at the bottom as shown in FIG. 4. These traps (41) have small holes (42) at their tops to allow captured contaminants and other contaminants to move upward towards the top of the collection chamber where they are retained. The collection chamber can be made of plastic, metal, glass, a composite material or other materials impervious to the contaminates being processed.

In FIG. 3, liquids from the pump are forced in an upward direction over a barrier (32) and have to come back down to exit. This motion directs the lighter liquids up towards the traps (31) where they are caught by the small cells formed by vertical surfaces running from side to side and attached to the interior upper surfaces of the collection chamber (41). These cells have small holes (42) at their top so the lighter liquids can all move to the highest spaces for collection and discharge later through a tube at the top (33) controlled by the valve shown.

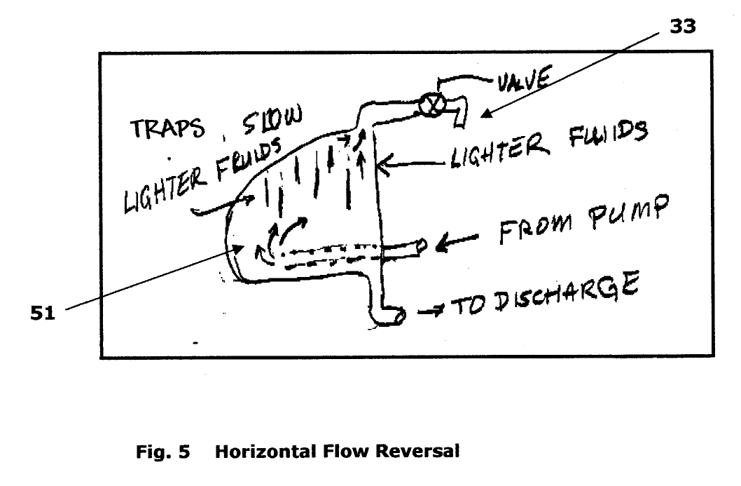

In FIG. 5, the liquids are forced upward in a reversing horizontal motion (51) with the lighter liquids being detained and captured by the traps. These lighter liquids collect in the upper reaches of the separator for discharge later through a tube at the top (33) controlled by the valve shown.

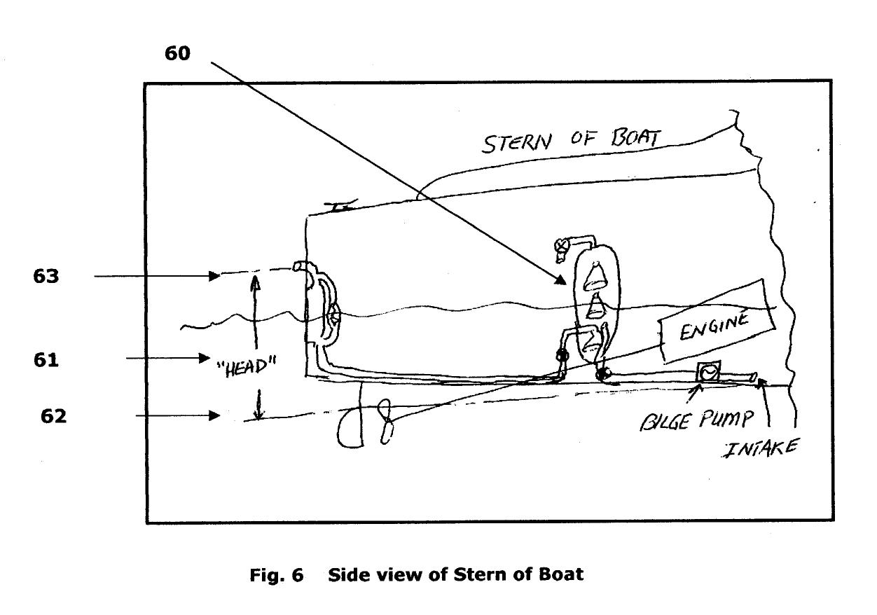

Another way to prevent or greatly reduce the discharge of contaminated liquids is to pass the liquids through a vertical pressure chamber (60) with traps for the contaminants. Catch-basins are by definition located at lower levels in land applications and in ships, in the bottom of the hull where leakage, rain and liquids of all types collect. Catch-basin pumps draw these liquids from these low spaces and pump them up to a discharge point somewhere above sea level, usually several feet above sea level in even a small vessel as shown in FIG. 6. This vertical distance is known as the “head”—the height between the catch-basin pump intake (62) and the catch-basin discharge point (63), usually through the hull (64) of the ship—a height that the catch-basin pump must be able to overcome with sufficient pressure so as to discharge the liquids to the environment.

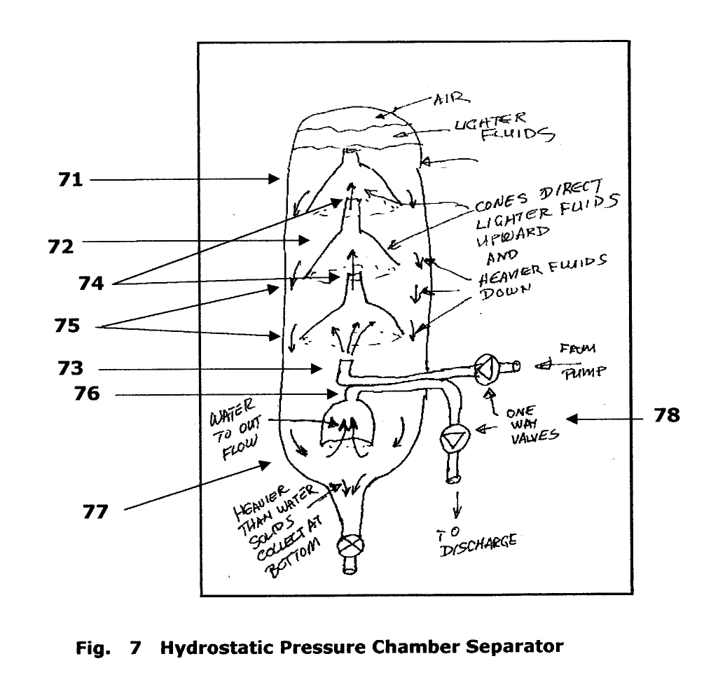

The hydrostatic pressure of this “head” (62-to-63) is used in a vertically mounted pressure chamber (71) to trap contaminants as shown in FIG. 7. The contaminated liquids collected in the catch-basin leave the pump and enter this chamber directed in an upward motion (73). In this chamber the contaminated liquids experiences the full extent of the hydrostatic pressure generated by the “head” (62-to-63). It is this pressure that is used to separate the lighter contaminated liquids from the heavier, un-contaminated liquids. Since this hydrostatic pressure is the pressure the catch-basin pump must produce to move liquids from the catch-basin to the height of the overboard discharge point, the hydrostatic pressure chamber does not increase the pressure the pump must generate to discharge liquids overboard. This is a key advantage of this invention.

This chamber has a series of internal structures shaped like inverted cones or inverted funnels (72). These structures keep the lighter, contaminated liquids in the center of the pressure chamber and direct them upward (74) while the heavier, un-contaminated liquids are directed to the edges of the chamber and downward (75). There is ample space between the structures and the edge of pressure chamber to allow the heavier liquids to flow down, thus separating the decontaminated, clean heavier liquids from the lighter contaminants retained above.

Below the entry point of the contaminated liquids from the catch-basin pump, uncontaminated liquids exit from the chamber in an upward direction (76), reversing its vertical flow direction a second time (77), enhancing the forces directing the heavier liquid and solid contaminant to the sludge collector at the bottom of the chamber. From this exit point, the uncontaminated liquid continue on to a hydrophobic filter canister and then to the discharge point (shown if FIG. 6). One way valves (78) where the liquids enter and exit the chamber prevent liquids trapped in the chamber from flowing back into the catch-basin when the pump is off.

The hydrostatic pressure of the at least several feet of the height of the chamber provides much greater separation forces for liquids of different specific gravities than can be realized in shallows of most catch-basins, usually only a few inches in depth. These forces can be ten to twenty of times greater than the separation forces in the catch-basin. Also, since the hydrostatic separation chamber greatly reduces the surface area of the catch-basin liquids, the mixing of contaminated and uncontaminated liquids on the surface due to the large surface area and action of surface tensions of the liquids is greatly reduced. Moreover, as the chamber is a closed container with a small surface area relative to its volume, the action of the vessel due to sea conditions in mixing the liquids is greatly reduced. For this reason, the liquids separated by hydrostatic forces tend to remain separated even when the chamber is subjected to the various pitching and rolling motions of a ship in heavy or confused seas.

The lighter contaminants in the main chamber (83) collect at the top in a detachable container (81) which is periodically isolated by means of a valve (82) and then removed and emptied of its contents which are then disposed of according to environmental regulations.

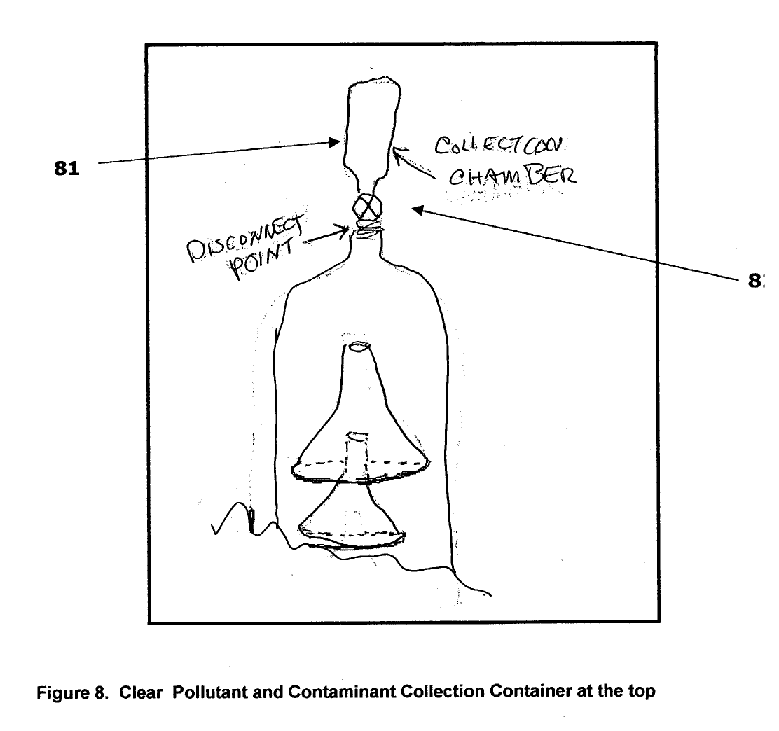

To facilitate the use of the separation and filtration system, the hydrostatic chamber (83) is made of a transparent material such as Plexiglas and the collection chamber at the top is made of a transparent material such as Plexiglas, plastic or glass so its collection of contaminants can be monitored as shown in FIG. 8. This container can be disconnected from the hydrostatic separating and filtering chamber when its contents are emptied using the valve to isolate the capture-chamber from the rest of the chamber.

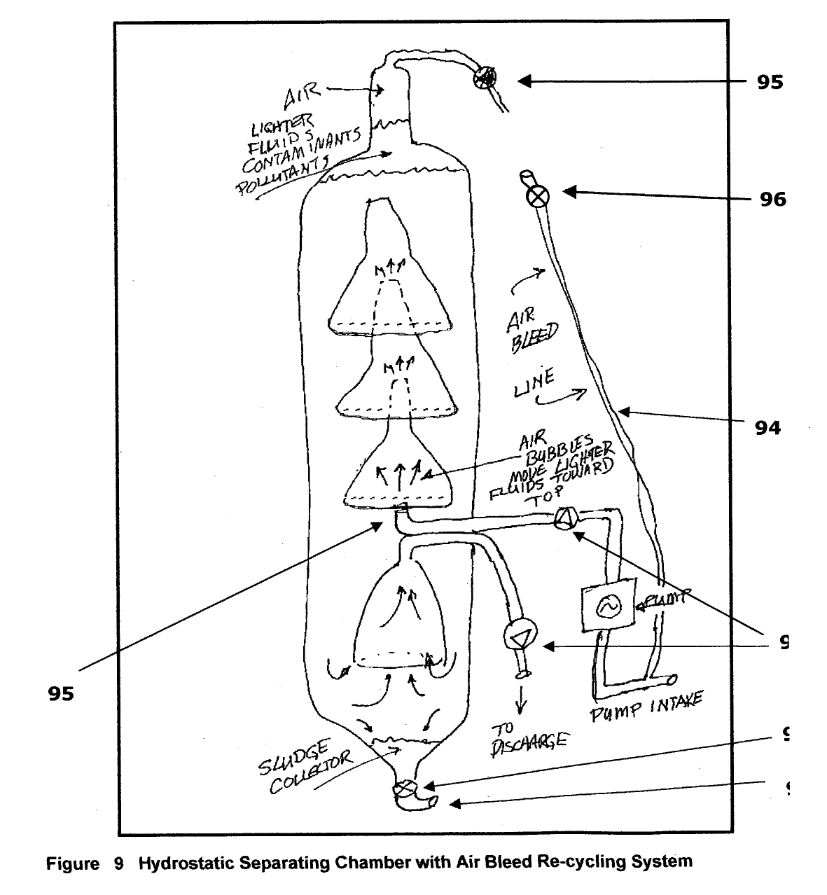

Another variation of this basic hydrostatic pressure separator (FIG. 9) involves enhancing the action of the hydrostatic pressure in moving the lighter liquids to the surface by allowing a stream of air delivered via a air-bleed tube (94) to bleed into the intake line of the pump from the area above the catch-basin, mixing air into the contaminated liquids collected by the pump. When this air and contaminated liquids mix enter the hydrostatic separation chamber, they are directed in an upward direction and the air bubbles support the upward flow carrying with them the lighter liquids. The flow of liquids and air into and out of the hydrostatic chamber is controlled by one way valves (91) that prevent liquids from draining from the hydrostatic chamber.

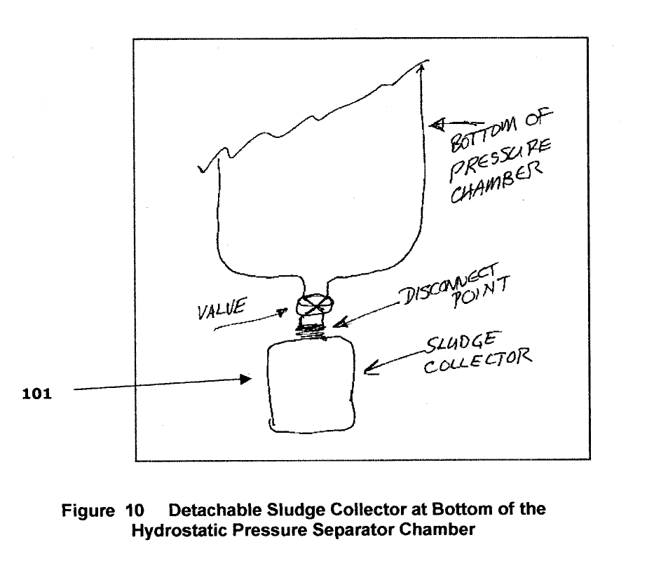

Heavier solid and liquid contaminants collect at the bottom of the chamber where they are periodically drained into an external container via a valve (92) and a drain pipe (93). An alternative design (FIG. 10) includes a detachable sludge collector (101) that is isolated by means of a valve when the sludge collector is removed for disposal of its contents.

The action of the air added to the stream of contaminated liquids pumped from the catch-basin is multifold: first, it provides an upward flow, current and mechanical force directing all lighter liquids towards the area at the top of the chamber to be captured and delivered to the capture-chamber; second, the bubbles provide and create tiny areas of surface where lighter liquids which float on the surface become trapped by their surface tension and then are delivered to the capture-chamber by the upward path of the air bubbles; and third, the air stream bubbles attach to particulate and suspended particles that otherwise would either escape into the external environment in the de-contaminated liquids pumped overboard or settle in the bottom of the chamber creating a sludge of heavier matter.

To keep the particulate and suspended particles of contaminants which are dragged to the upper collection chamber by bubbles of the air stream from re-mixing, the pressure chamber has a series of internal structures mounted vertically, one on top of another, each structure in the shape of an inverted cone or funnel (123) having a cross section similar to an inverted letter “V” or “y” which direct the air bubbles and lighter liquids upward. The heavier liquid reverses its initial upward direction moving with the air and mix of contaminated liquids arriving from the catch-basin pump to a downward direction along the outer edges of the chamber, allowing the air bubbles, lighter contaminants and other contaminants to continue in an upward direction in the center of the chamber.

Mounted in the lower portion of the chamber below the upward directed tube or pipe introducing the contaminated liquid with its attendant air stream which is injected into the chamber by the action of the catch-basin pump is another structure in the shape of an inverted cone or funnel (126) having a cross section similar to an inverted letter “V” or “Y” the top of which is connected to an exit tube. The de-contaminated liquid has to reverse its vertical flow direction again (127), leaving the heavier sludge, suspended particulates and other contaminants to continue their downward direction to the lower collection chamber.

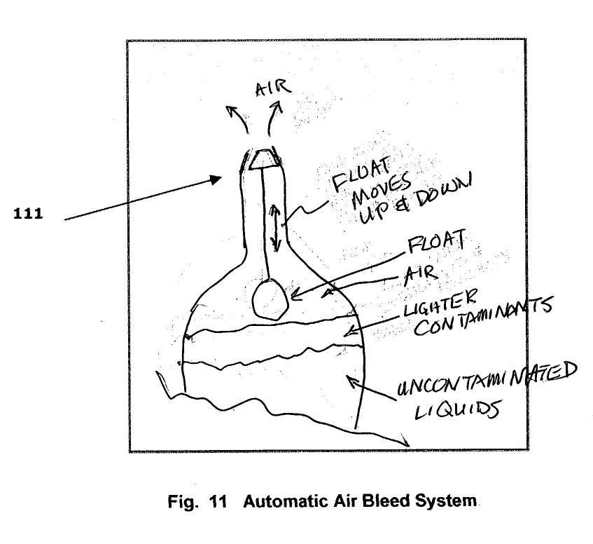

While adding a stream of air into the liquids and contaminants collected by the catch-basin pump facilitates in separating legally dischargable liquids from illegal contaminants, the addition of air into the stream of contaminated liquids collected from the catch-basin means that this air will collect and quickly fill the separation chamber with air, necessitating a means for continuously bleeding off this air stream. This can be accomplished by a mechanical device (111) linked to a float riding on the top level of the Liquids in chamber as shown in FIG. 11.

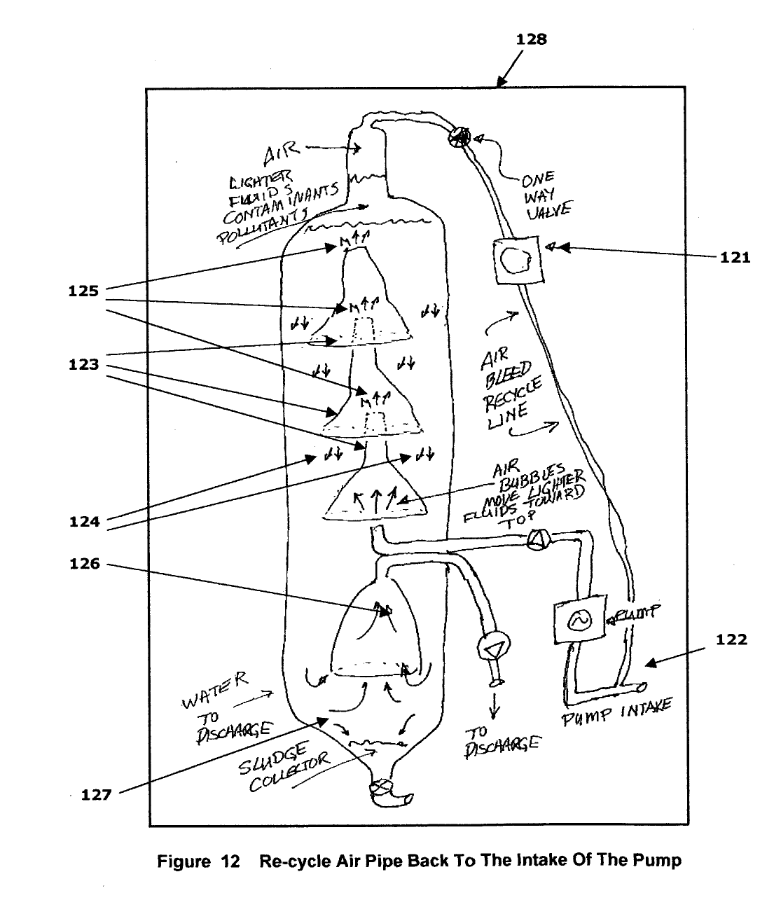

A far more practical mechanism involves re-cycling the air from the top of the contaminant-capture chamber back to the intake of air into the catch-basin pump using a small tube as shown in FIG. 12. A valve (128) in the bleed-air line is used to regulate the amount and flow of the air re-cycled and being introduced to the pump intake. The re-cycled air passes through a filter (121) to remove hydrocarbon vapors which may be explosive. A one-way valve in the small tube prevents air in the tube from re-entering the chamber which would allow the chamber to drain, returning the collected contaminants into the catch-basin if the one-way valve between the pump and the chamber fails.

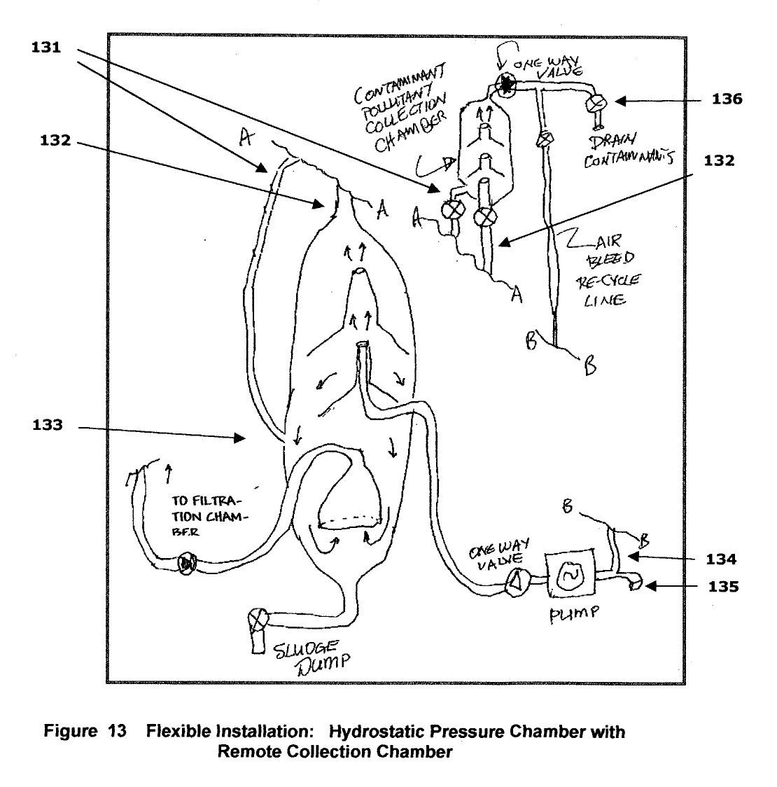

An alternative design for removing the contaminates from the capture chamber allows the air bleeder hose to be used to pump the collected contaminants into a separate container for proper disposal as required by environmental regulations. In this design, when the catch-basin pump is turned on, a valve (136) is opened allowing the action of the catch-basin pump to push the air and contaminants and other contaminates collected at the top of the chamber out through the drain. See FIG. 13. When the separated contaminants collected at the top have been pumped out of the hydrostatic separation chamber, the catch-basin pump is turned off and the valve is adjusted so as to allow enough air to be sucked back into the separation chamber to continue the air stream re-cycling action.

The pressure chamber does not have to be a large, bulking structure, but can be quite flexibly designed with a lower portion located in the catch-basin area and an upper portion at a location convenient for monitoring and removing the collection of contaminants for disposal as required by environmental regulations, as shown in FIG. 13. The top collection chamber, drain valve and air bleed tube (134) can be remotely located from the bottom of the structure provided the two parts remain attached by tubes (131 and 132) running from one to the other as shown in FIG. 13. The upper tube delivers the air bled into the catch-basin pump intake and the lighter contaminants and hydrocarbons to the upper chamber and a second tube returns uncontaminated liquids to the lower chamber (133) below the entry point of the air and liquid mix from the pump. The cross-section of the upper tube is at least two to three or more times as large as the cross section of the tube exiting the catch-basin pump and the lower, return tube is about half the cross-section of upper tube.

The top portion can be located at a convenient place higher up in the vessel with the limitation that the level of the liquids in the upper chamber will not be higher than the catch-basin discharge pipe. Valves in the tubes (131 and 132) between the top and the bottom chambers are used to prevent contaminants gathered at the top from returning to the lower chamber and eventually to either the catch-basin via the intake point (135) or overboard.

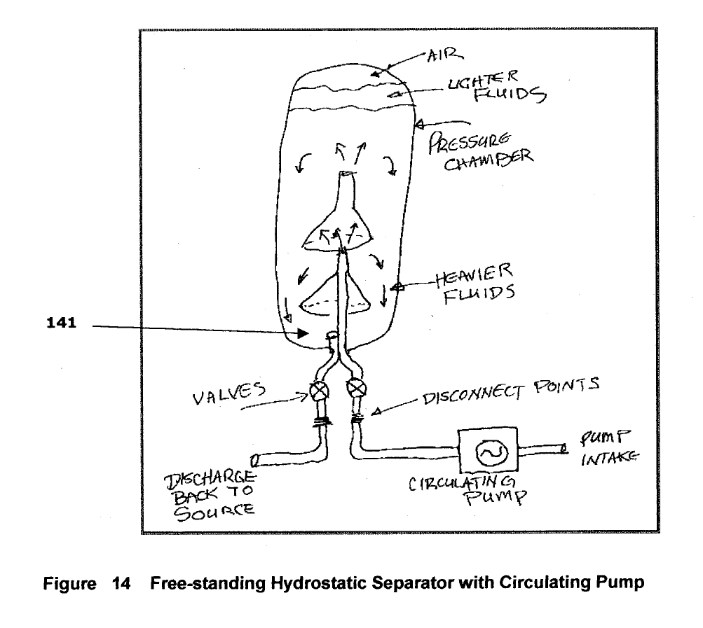

Finally, the automatic separation of lighter contaminants by the pressure chamber can be used at anytime, not just when the catch-basin pump is in operation. This is accomplished by adding a small circulating pump to move small amounts of contaminated liquids through the pressure chamber and back into the catch-basin as shown in FIG. 14. A one-way valve between the re-circulating pump and the chamber prevents liquids from the chamber from flowing back through the re-circulating pump. The discharge from the re-circulating pump (141) can be shut off by a valve when not in use or allowed to re-cycle some of the de-contaminated liquid when the catch-basin pump is in use.

Since aqueous solutions expand very little with increasing temperature relative to the much higher expansion of hydrocarbon-based and hydrocarbon-containing contaminants, increasing temperature acts to increase the gravitational separation forces. This results when the specific gravity of the hydrocarbon-based and hydrocarbon-containing contaminants decreases due to greater expansion of these liquids with increasing temperature than the expansion of aqueous solutions. This can occasionally be seen in the cooling discharge exiting from engines even when the exiting coolant has only been through a heat exchanger, not through the engine itself, and has no contaminants added by passing through the engine. Where the coolant drawn in from around the ship is already polluted with assorted invisible and other suspended hydrocarbons, the increase in temperature resulting from passage through the heat exchanger creates the appearance of hydrocarbon-based contaminants in the coolant discharge.

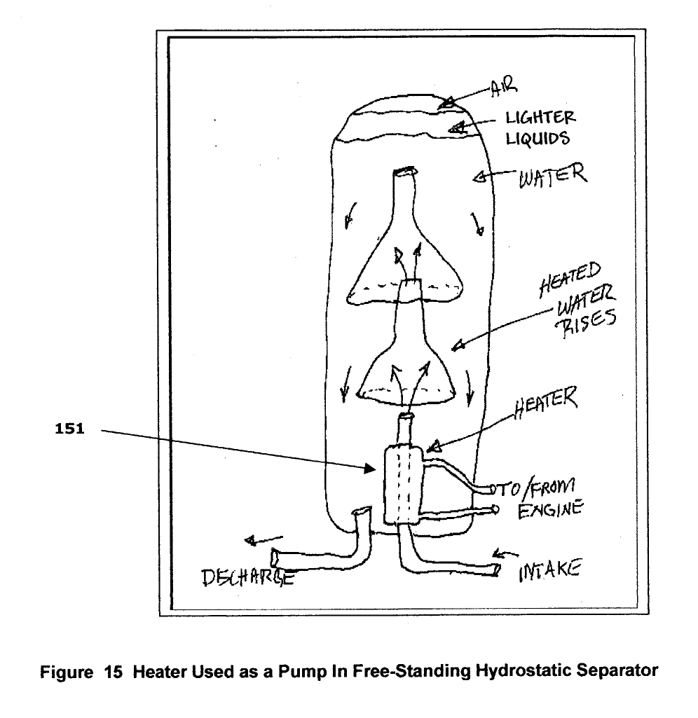

By heating the contaminant liquids drawn from the catch-basin, this temperature effect can be used to enhance the separation of hydrocarbon-based and hydrocarbon-containing contaminants, especially when coupled with the much greater separation forces of the pressure separation chamber described above. This heater (151) is shown in FIG. 15. In lieu of a small circulating pump in a stand alone contaminant separator, the low grade or waste heat from the engine can be used to provide continuous pumping forces whenever the engine is in operation.

The source of this heat can be the waste heat of the engine, a separate electrical heater or any other source of low-grade or low temperature heat. This heat can be applied continuously whenever the engine is running, providing automatic continuous increased separation forces. The use of the waste heat of the engine provides a continuous pumping action within the hydrostatic chamber as the heated liquids rises to the upper chamber, effecting a continuous heat-enhanced separation action. The value of this is not evident until the catch-basin pump is activated. The aqueous liquid collected by the pump has been being continuously de-contaminated while the heat pump is in operation so that the contaminated liquid in the catch-basin has been pre-cleaned over a much longer time period than allowed during operation of the catch-basin pump which has as its primary function, removing quickly and efficiently any significant collections of unnecessary, potentially destabilizing liquids from within the hull.

As shown in FIG. 15, the heated liquids rise carrying the hydrocarbon, hydrocarbon-based and hydrocarbon-containing contaminants to the top of the chamber as the heavier liquids exit at the bottom of the chamber. The same capture-chamber used for the catch-basin pump described above is used here.

In the catch-basins of many ships, the salinity of the liquids varies across a wide range. From leaks in the upper decks and structure, rain with little or no salinity collects in the catch-basin. This forms a low salinity liquid that attracts from contaminants coating the internal surfaces of the catch-basins and hold insolution a different group of hydrocarbons, usually the lighter contaminants and hydrocarbon liquids, than the much saltier liquids do. These fresh and low salt liquids not only present a different mix of contaminants and other contaminants, they have a lower density than high salt liquids derived from the ocean. Hence, the operation of the hydrostatic separation system for low salt liquids is enhanced by the addition of salt to the liquids in the hydrostatic chamber. The addition of salt to the chamber in a form such as rock salt, sea salt, Epson salts or salts in solution form through a tube (161) will bring the liquid in the hydrostatic chamber up to the saline saturation level the contaminated liquid.

Since the heavier salts will settle in the bottom of the chamber, a small tube (162) internal to the hydrostatic chamber is added. This tube is vertically mounted, running from near the bottom of the chamber to a position next to and parallel to the upwardly directed air and liquid mix entry point. The action of the upward flow of the air liquid mix draws the heavier salt solutions off the bottom to mix with air and liquid as it inters the chamber. In applications where the addition of salt is not practical or environmentally acceptable, such as on in-land lakes, the height and volume of the chamber must be maximized so as to allow more hydrostatic pressure and space for the slower separation process of low-salt liquids to take place.

While a dynamic renewable, continuous separation and filtration system—dynamic in the sense of operating on the catch-basin contents when the catch-basin pump is operating—is preferable to no system and to more limited systems, the time for the system to achieve the goal of removing contaminants, hydrocarbons and other contaminants is very brief. While the separation and filtration system is always available, it is not making much contribution to separating and filtering the contents of the catch-basin except when the catch-basin pump is operating. While a separate stand-alone separation and filtration system with a small circulating pump can be used as described above, this requires the installation of two systems. Space requirements and cost considerations may not always allow for two systems, especially in smaller craft.

The need for two separate systems can be avoided by using a either a two speed catch-basin pump or a second, small capacity circulating pump (163) to move small volumes of contaminated liquid through the separation and filtration system while the main catch-basin pump is not operating. This small pump collects liquids from the catch-basin and delivers them through a one-way valve to the hydrostatic separation chamber in an upward motion just as the catch-basin pump does.

After passage through the hydrostatic separation chamber and filtration chamber, the small volume of contaminated liquid from the re-circulating pump is returned to the catch-basin by way of a drain mounted at a level nearly as high as the main overboard discharge tube. In the alternative, the main catch-basin discharge tube that connects the output of the filtration system to the point where the contents of the catch-basin are discharged overboard and into the aqueous environment has a small hole (170) which drains into a sink-like collector connected to drain tube (173) which has sufficient capacity to carry and return to the catch-basin the limited volume of aqueous liquid pumped by the small circulating pump into the system when the catch-basin pump is not operating.

Depending on the capacity of the catch-basin pump and the frequency of its use—its “cycle time”—the small drain tube (173) is used to return de-contaminated liquids to the catch-basin or to the discharge point. Where the cycle time is long and leakage into the catch-basin is low, the return drain tube (173) is directed back into the catch-basin. Where there is a frequent need to operate the main catch-basin pump, the output from the small re-circulating pump is discharged to the holding tank in a land-based application or into the external environment in an application on a ship. The small re-circulating pump (177) is run continuously, run on a timer or by a control system which turns the circulating pump on for a variable period of time after each instance when the catch-basin pump is cycled on and off.

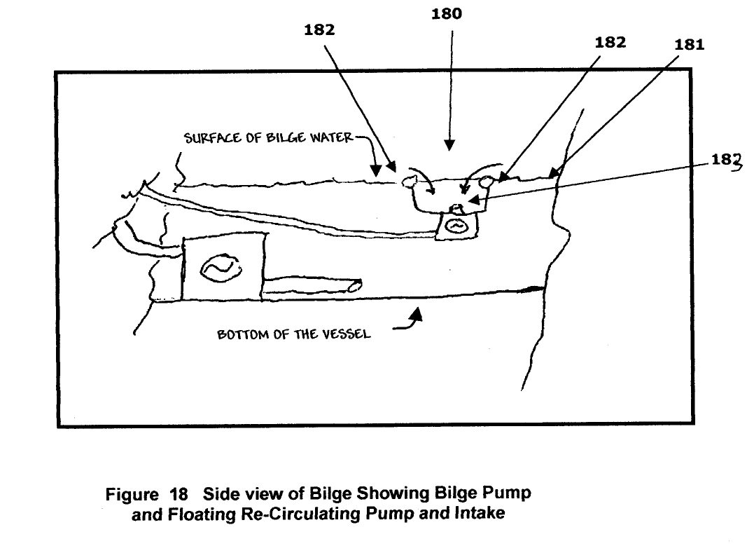

While the collection point for the catch-basin pump is at a point low in the catch-basin to minimize the collection of contaminants, hydrocarbons and other contaminants floating on or near the surface of the liquids in the catch-basin, the collection point (180) for the small circulating pump is located and held at the surface of the aqueous liquid (181) by floats (182) so as to gather as much of the lighter contaminants, hydrocarbons and other contaminants floating or on near the surface as possible. This collector is shown in FIG. 18. The collector floats on the surface with an intake (183) at the bottom of the collector so that liquids collected by the recirculating pump come to the extent possible from the surface of the catch-basin, maximizing the intake of lighter contaminants, hydrocarbons and other contaminants floating or on near the surface. By collecting the lighter contaminants continuously, the opportunity of the contaminated liquids to mix with the un-contaminated liquid due to the motion of the vessel is reduced to a minimum. In this manner, the re-circulating pump removes contaminants from the catch-basin contents while the catch-basin pump is off so that when the catch-basin pump is operated, the task of the separation and filtration system is facilitated by having cleaned to the extent possible the contents of the catch-basin before the catch-basin pump goes into operation and the separation and filtration system goes into operation.

The tube re-cycling the bleed air from the vapor filter to the intake of the catch-basin pump has a series of small holes at the end of the tube where it delivers air to the intake of the catch-basin pump so that the re-cycled bleed air is a stream very small bubbles. These small holes are not necessary for catch-basin pumps whose pumping action breaks any air bubbles into very small bubbles such as is the case with centrifugal pumps.

The cross-section of the upper and lower chambers of the first stage are 10-to-20 times the cross section of the pipe exiting the catch-basin pump so that the liquids of different densities have sufficient space for the hydrostatic and thermal forces moving lighter liquids upward to overcome the hydrostatic and pumping forces moving the heavier liquids down.

The heat which enhances the separation process can be applied to the contaminated liquids entering separator, but is most efficiently applied between the upper and lower chambers, heating only the liquid and air being delivered to the upper chamber. This heat can be derived from the waste heat of the engine or from any other source.

In applications where the contaminated liquids in the catch-basin are low in salinity, salt is added to the air and liquid mix as it enters the chamber by action of a tube connecting the lower reaches of the chamber with entering stream of mixed air and liquid. Salts such as rock salts, sea salts, Epson salts, mineral salts or salts in liquid form are added to the chamber each time the collected contaminants and other contaminants are removed from the collection chambers.

### DETAILED DESCRIPTION OF PREFERRED EMBODIMENT

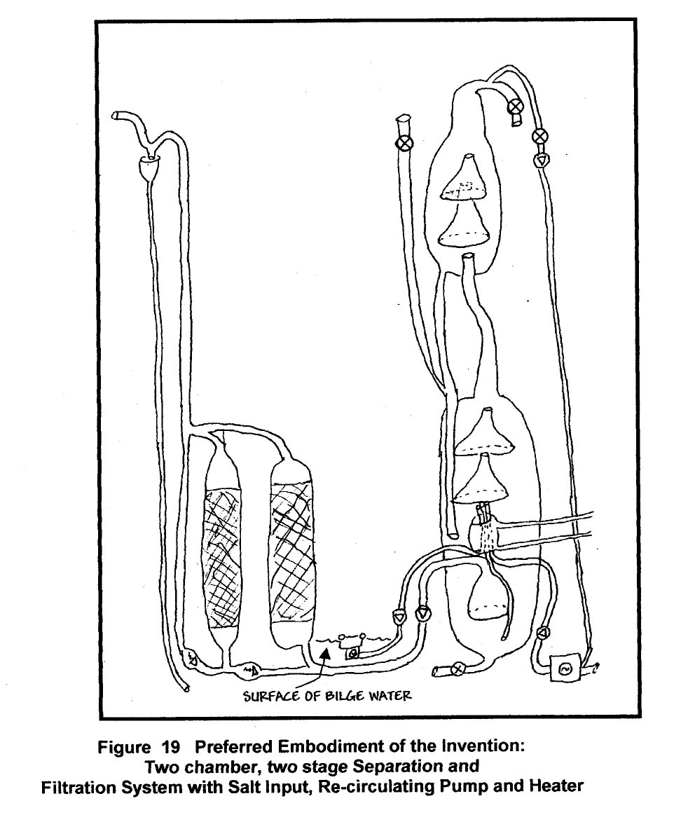

The preferred embodiment shown in FIG. 19 includes a heated automatic hydrostatic filtering system with a flexible two-part first stage which includes a heater and re-cycling air-bleed system of vertically mounted upper and lower chambers with internal inversely mounted funnel like structures, connected by a pipe or tube delivering the bleed-air and lighter hydrocarbons and other contaminants from the lower to the upper chamber and a return pipe or tube returning the separated de-contaminated liquid to the lower chamber, a separate tube and valve for adding salt to the chambers, a separate return tube at the top of the upper chamber re-cycling the bleed air through a filter with a hydrocarbon vapor absorbing material to the intake of the catch-basin pump and second stage having a by-pass valve for a blocked filter, which receives the decontaminated liquid from the first stage, passes it through the hydrophobic filtering stage before sending the cleaned liquid through the discharge port into a holding tank or to the external environment.

What is claimed is:

1. A separation and filtration system comprising:
(a) a first stage collection chamber;
(b) means for transporting a contaminated liquid to and into a chamber from a supply of the liquid selected from the group consisting of (i) a sump, (ii) a catch-basin, (iii) a pan, (iv) the lowest levels in a hull, (v) a source of contaminated liquids.

2. The separation and filtration system according to claim 1, wherein the means for transporting the liquid is a pressure generator selected from the group consisting of (i) a mechanical pump, (ii) a thermal pump, (iii) a manual pump.

3. The separation and filtration system according to claim 2, wherein the means for transporting the liquid to and into the separation and filtration chamber from the supply includes a first tube which runs both between the supply and the pressure generator and includes a second tube which runs between the pressure generator and a one-way valve and between the one-way valve and to and into an aperture on the lower part of the separation and filtration chamber.

4. The separation and filtration system according to claim 3, further comprising means for transporting the liquid from the chamber to and into a filter.

5. The separation and filtration system according to claim 4, further comprising means for transporting the liquid from the filter to a discharge point.

6. The separation and filtration system according to claim 5, wherein the chamber, further includes an internal structure in the shape of an inverted cone and located above the entry point of the second tube into the chamber.

7. The separation and filtration system according to claim 6 further includes an upward directed nozzel attached to the second tube where it enters into the chamber.

8. The separation and filtration system according to claim 7 further includes a second internal structure in the shape of an inverted cone and located below the entry point of the second tube into the chamber and attached at its upper end to the third tube.

9. The separation and filtration system according to claim 8 further includes a forth tube running between the top of the chamber and a two-way valve and the two-way valve and a final disposition selected from the group consisting of (i) a discharge tube, (ii) a removable container, (iii) a holding tank.

10. The separation and filtration system according to claim 9 further includes a means to heat the liquid after it is removed from the source and before it enters the chamber.

11. The separation and filtration system according to claim 10 further includes a fifth tube running from a source of salt to a two way valve and to and into the chamber at a level above the entry point of the second tube.

12. The separation and filtration system according to claim 11 further includes a sixth tube running between the top of the chamber and a two-way valve and from the two-valve to the intake of the pressure generator.

13. The separation and filtration system according to claim 12 further includes a seventh tube mounted inside the chamber, running from the lower level of the chamber, aroun the lower inverted cone shaped structure to a point adjacent to the upward directed nozzel attached to the second tube.

14. A separation and filtration system comprising:
(a) a first stage collection chamber;
(b) means for transporting a contaminated liquid from an intake point to and into a cham ber from a supply of the liquid selected from the group consisting of (i) a sump, (ii) a catch-basin, (iii) a pan, (iv) the lowest levels in a hull, (v) a source of contaminated liquids.

13. The separation and filtration system according to claim 14, wherein the means for transporting the liquid is a pressure generator selected from the group consisting of (i) a mechanical pump, (ii) a thermal pump, (iii) a manual pump.

14. The separation and filtration system according to claim 13, wherein the intake point is attached to a skimming device which draws from the surface of the source the liquid transported by the pump.

15. The separation and filtration system according to claim 13, wherein the means for transporting the liquid to and into the separation and filtration chamber from the supply includes a first tube which runs both between the supply and the pressure generator and includes a second tube which runs between the pressure generator and a one-way valve and between the one-way valve and to and into an aperture on the lower part of the separation and filtration chamber.

15. The separation and filtration system according to claim 14, further comprising means for transporting the liquid from the chamber to and into a filter.

16. The separation and filtration system according to claim 15, further comprising means for transporting the liquid from the filter to the source.

17. The separation and filtration system according to claim 16, wherein the chamber, further includes an internal structure in the shape of an inverted cone and located above the entry point of the second tube into the chamber.

18. The separation and filtration system according to claim 17 further includes an upward directed nozzel attached to the second tube where it enters into the chamber.

19. The separation and filtration system according to claim 18 further includes a second internal structure in the shape of an inverted cone and located below the entry point of the second tube into the chamber.

20. The separation and filtration system according to claim 19 further includes a forth tube running between the top of the chamber and a two-way valve and the two-way valve and a final disposition selected from the group consisting of (i) a discharge tube, (ii) a removable container, (iii) a holding tank.

21. The separation and filtration system according to claim 20 further includes a means to heat the liquid after it is removed from the source and before it enters the chamber.

22. The separation and filtration system according to claim 21 further includes a fifth tube running from a source of salt to a two way valve and to and into the chamber at a level above the entry point of the second tube.

23. The separation and filtration system according to claim 22 further includes a sixth tube running between the top of the chamber and a two-way valve and from the two-valve to the intake of the pressure generator.

24. The separation and filtration system according to claim 23 further includes a seventh tube mounted inside the chamber, running from the lower level of the chamber, aroun the lower inverted cone shaped structure to a point adjacent to the upward directed nozzel attached to the second tube.
